(19) United States
(12) Patent Application Publication
(10) Pub. No.: US 2014/0291418 A1
(43) Pub. Date: Oct. 2, 2014

(54) MULTI-CIRCUIT AIRBLAST FUEL NOZZLE

(71) Applicant: Parker-Hannifin Corporation, Cleveland, OH (US)

(72) Inventors: Mark P. Ruffing, Mentor, OH (US); Robert R. Pelletier, Chardon, OH (US); Erlendur Steinthorsson, Pepper Pike, OH (US)

(21) Appl. No.: 14/225,916

(22) Filed: Mar. 26, 2014

Related U.S. Application Data
(60) Provisional application No. 61/805,169, filed on Mar. 26, 2013.

(51) Int. Cl. F02C 7/232

(52) U.S. Cl. CPC F02C 7/232
USPC 239/403

(57) ABSTRACT

Provided is a nozzle for an injector including a nozzle body disposed interiorly of an air swirler, the nozzle body including a plurality of sets of multiple exit orifices arranged in an annular array with the orifices of one set alternating with the orifices of another set, wherein the plurality of exit orifices terminate at an end face of the nozzle body upstream of a common prefilmer orifice. Fuel may be directed through the orifices at varying angles and flow rates to allow for varying fuel metering and fuel swirl during staging.

### RELATED APPLICATIONS

This application claims the benefit of U.S. Provisional Application No. 61/805,169 filed Mar. 26, 2013, which is hereby incorporated herein by reference.

### FIELD OF THE INVENTION

The present invention relates generally to turbine engines, and more particularly to injectors for turbine engines having a plurality of multi-circuit fuel nozzles.

### BACKGROUND

A turbine engine typically includes an outer casing extending radially from an air diffuser and a combustion chamber. The casing encloses a combustor for containment of burning fuel. The combustor includes a liner and a combustor dome, and an igniter is mounted to the casing and extends radially inwardly into the combustor for igniting fuel.

The turbine also typically includes one or more fuel injectors for directing fuel from a manifold to the combustor. Fuel injectors also function to prepare the fuel for mixing with air prior to combustion. Each injector typically has an inlet fitting connected either directly or via tubing to the manifold, a tubular extension or stem connected at one end to the fitting, and one or more spray nozzles connected to the other end of the stem for directing the fuel into the combustion chambers. A fuel passage (e.g., a tube or cylindrical passage) extends through the stem to supply the fuel from the inlet fitting to the nozzle. Appropriate valves and/or flow dividers can be provided to direct and control the flow of fuel through the nozzle. The fuel injectors are often placed in an evenly-spaced annular arrangement to dispense (spray) fuel in a uniform manner into the combustion chamber. Additional concentric and/or series combustion chambers each require their own arrangements of nozzles that can be supported separately or on common stems. The fuel provided by the injectors is mixed with air and ignited, so that the expanding gases of combustion can, for example, move rapidly across and rotate turbine blades in a gas turbine engine to power an aircraft, or in other appropriate manners in other combustion applications.

### SUMMARY OF INVENTION

The present invention provides a nozzle for an injector including a nozzle body disposed interiorly of an air swirler, the nozzle body including a plurality of sets of multiple exit orifices arranged in an annular array with the orifices of one set alternating with the orifices of another set, wherein the plurality of exit orifices terminate at an end face of the nozzle body upstream of a common prefilmer orifice. Fuel may be directed through the orifices at varying angles and flow rates to allow for varying fuel metering and fuel swirl during staging.

According to one aspect of the invention nozzle for an injector is provided that includes an air swirler, and a nozzle body disposed interiorly of the air swirler, the nozzle body including a plurality of inlet chambers configured to be fluidly connected to respective fuel circuits, a plurality of sets of multiple exit orifices arranged in an annular array with the orifices of one set alternating with the orifices of another set, and a plurality of sets of multiple flow passages extending through the nozzle body, wherein each of the multiple flow passages is fluidly connected to one of the exit orifices, and wherein each set of multiple flow passages fluidly connects one of the plurality of inlet chambers with one of the plurality of sets of multiple exit orifices.

The plurality of exit orifices may terminate at an end face of the nozzle body upstream of a common prefilmer orifice of the air swirler and are configured to direct fluid towards a prefilmer surface terminating at the prefilmer orifice.

The nozzle may further include an inner annular wall disposed interiorly of the fuel swirler and defining an air passage through which air flows.

The plurality of inlet chambers may be offset from one another radially with respect to the air passage.

The plurality of inlet chambers may be concentric.

A terminal portion of each flow passage of one of the sets of multiple flow passages may have a cross-sectional area less than a cross-sectional area of a terminal portion of each flow passage of another set of multiple flow passages.

Each terminal portion of each flow passage in each set of multiple flow passages may have the same cross-sectional area as the other terminal portions in the same set of multiple flow passages.

Each flow passage may include a terminal portion angled with respect to a central axis circumscribed by the nozzle body for directing fuel to the respective exit orifice, wherein the terminal portions of one of the sets of multiple flow passages are angled at a different angle than the terminal portions of another of the sets of multiple flow passages such that the fluid exiting each set of multiple exit orifices has a different spray angle than the other sets of orifices.

Each terminal portion of each flow passage in each set of multiple flow passages may be angled with respect to the central axis at the same angle as the other terminal portions in the same set of multiple flow passages.

Each terminal portion may be formed by a passage extending between a downstream end of the respective flow passage and the respective exit orifice.

Each set of multiple exit orifices may have a spray angle that is angled with respect to a central axis circumscribed by the nozzle body such that the fluid exiting each set of multiple exit orifices has a different spray angle than the fluid exiting the other sets of multiple exit orifices.

The nozzle body may be a unitary construction.

According to another aspect of the invention, a nozzle is provided that includes an air swirler and a nozzle body disposed interiorly of the air swirler, the nozzle body including a plurality of inlet chambers configured to be fluidly connected to respective fuel circuits, a plurality of sets of multiple passages respectively fluidly connected to one of the inlet chambers, and a plurality of exit orifices respectively fluidly connected to one of the flow passages, wherein the plurality of exit orifices terminate at an end face of the nozzle body upstream of a common prefilmer orifice and direct fluid towards a prefilmer surface terminating at the prefilmer orifice.

The exit orifices may direct the fluid towards the prefilmer orifice between a tip of the nozzle body and the air swirler.

A terminal portion of each flow passage of one of the sets of multiple flow passages may have a cross-sectional area less than a cross-sectional area of a terminal portion of each flow passage of another set of multiple flow passages.

Each flow passage may include a terminal portion angled with respect to a central axis circumscribed by the nozzle body for directing fuel to the respective exit orifice, wherein the terminal portions of one of the sets of multiple flow passages are angled at a different angle than the terminal portions of another of the sets of multiple flow passages such that the fluid exiting each set of multiple exit orifices has a different spray angle than the other sets of orifices.

Each set of multiple exit orifices may have a spray angle that is angled with respect to a central axis circumscribed by the nozzle body such that the fluid exiting each set of multiple exit orifices has a different spray angle than the fluid exiting the other sets of multiple exit orifices.

According to yet another aspect of the invention, a fuel injection is provided that includes a housing stem having a bore extending therethrough, first and second fuel conduits extending through the bore, and a nozzle supported by the stem, the nozzle including an air swirler coupled to a downstream end of the housing stem, a nozzle body disposed interiorly of the housing stem and air swirler, and an inner annular wall disposed interiorly of the nozzle body and defining an air passage through which air flows, wherein the nozzle body includes a plurality of inlet chambers offset from one another radially with respect to the air passage, a plurality of flow passages fluidly connected to each inlet chamber, and a plurality of exit orifices each fluidly coupled to one of the plurality of flow passages.

The inlet chambers may have progressively smaller diameters.

The fuel injector may further include an annular shroud surrounding a downstream end of the air swirler for directing air flowing through swirler vanes of the air swirler radially inwardly.

The foregoing and other features of the invention are hereinafter described in greater detail with reference to the accompanying drawings.

### BRIEF DESCRIPTION OF THE DRAWINGS

FIG. 1 is a cross-sectional view of a portion of an exemplary gas turbine engine illustrating a fuel injector in communication with a combustor.

FIG. 2 is a cross-sectional view of a fuel injector showing details of an exemplary nozzle tip assembly in accordance with the invention.

FIG. 3 is a fragmentary cross-sectional view of the fuel injector.

FIG. 4 is a perspective view of an exemplary fuel swirler.

FIG. 5 is another perspective view of the fuel swirler showing flow passages extending through the fuel swirler in broken line.

FIG. 6 is a cross-sectional view of another fuel injector showing details of another exemplary nozzle tip assembly in accordance with the invention.

FIG. 7 is a fragmentary cross-sectional view of the fuel injector of FIG. 6.

FIG. 8 is another fragmentary cross-sectional view of the fuel injector showing flow passages extending through a fuel swirler in broken line.

FIG. 9 is a fragmentary cross-sectional view of the still another fuel injector in accordance with the invention.

FIG. 10 is a perspective view of an exemplary fuel swirler of the fuel injector of FIG. 9.

FIG. 11 is a cross-sectional view of the fuel swirler.

FIG. 12 is a partial top view of the fuel swirler.

### DETAILED DESCRIPTION

The principles of the present invention have particular application to fuel injectors and nozzles for gas turbine engines and thus will be described below chiefly in this context. It will of course be appreciated, and also understood, that the principles of the invention may be useful in other applications including, in particular, other fuel nozzle applications and more generally applications where a fluid is injected by a nozzle especially under high temperature conditions.

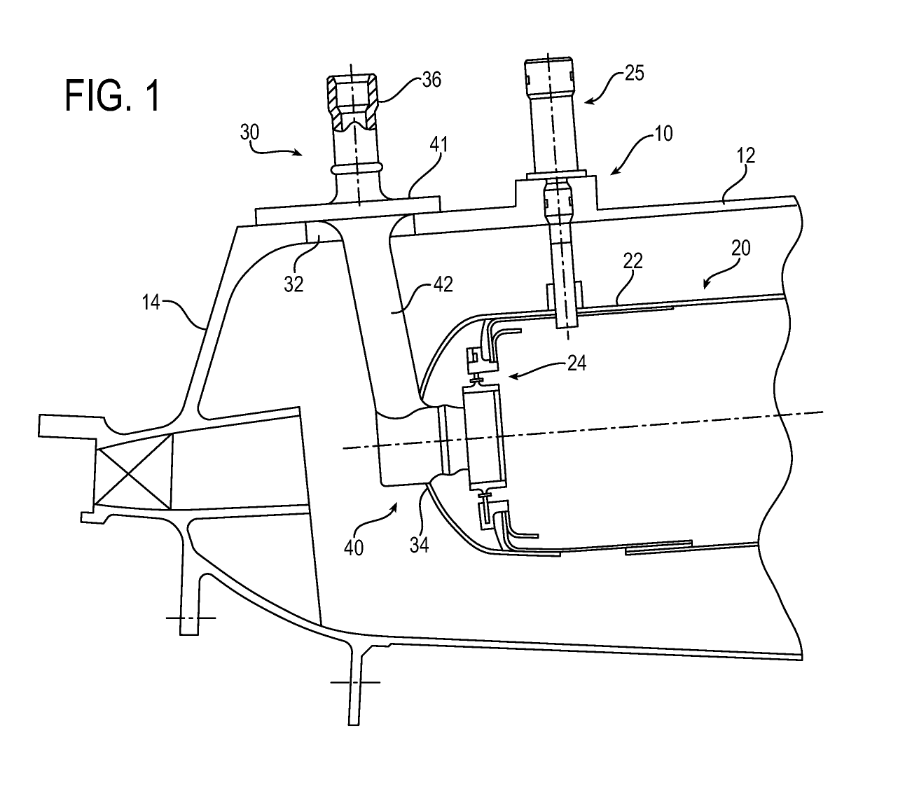

Referring now in detail to the drawings and initially to FIG. 1, a gas turbine engine for an aircraft is illustrated generally at 10. The gas turbine engine 10 includes an outer casing 12 extending forwardly of an air diffuser 14. The casing 12 and diffuser 14 enclose a combustor, indicated generally at 20, for containment of burning fuel. The combustor 20 includes a liner 22 and a combustor dome, indicated generally at 24. An igniter, indicated generally at 25, is mounted to the casing 12 and extends inwardly into the combustor 20 for igniting fuel. The above components can be conventional in the art and their manufacture and fabrication are well known.

A fuel injector, indicated generally at 30, is received within an aperture 32 formed in the engine casing 12 and extends inwardly through an aperture 34 in the combustor liner 22. The fuel injector 30 includes a fitting 36 exterior of the engine casing 12 for receiving fuel, as by connection to a fuel manifold or line; a fuel nozzle, indicated generally at 40, disposed within the combustor 20 for dispensing fuel; and a housing stem 42 interconnecting and structurally supporting the nozzle tip assembly 40 with respect to fitting 36. The fuel injector 30 is suitably secured to the engine casing 12, as by means of an annular flange 41 that may be formed in one piece with the housing stem 42 proximate the fitting 36. The flange 41 extends radially outward from the housing stem 42 and includes appropriate means, such as apertures, to allow the flange 41 to be easily and securely connected to, and disconnected from, the casing 12 of the engine using, for example, bolts or rivets.

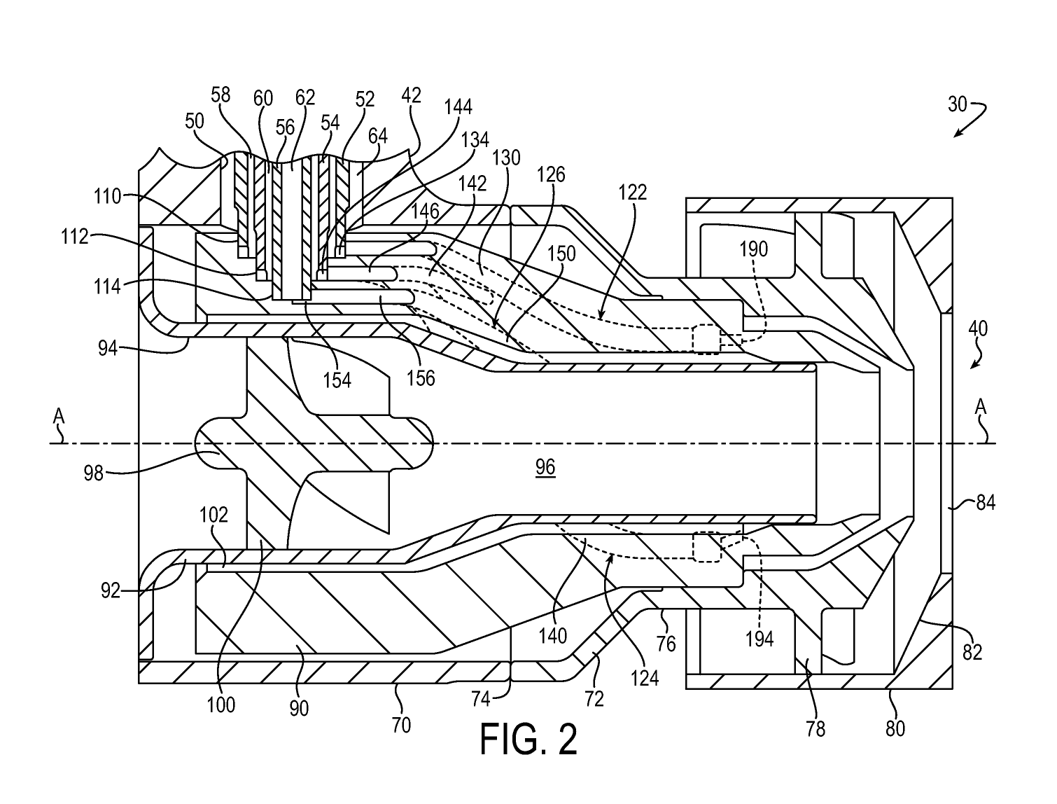

As best seen in FIG. 2 when viewed in conjunction with FIG. 1, the housing stem 42 includes a central, longitudinally-extending bore 50 extending the length of the housing stem 42. A plurality of fuel conduits 52, 54, and 56, such as concentric fuel conduits, extend through the bore 50 and fluidly interconnect fitting 36 and nozzle 40. The fuel conduits 52, 54, and 56 each have an internal passage 58, 60, and 62 respectively for the passage of fuel. The fuel conduits 52, 54, and 56 are surrounded by the bore 50 of the housing stem 42, and an annular insulating gap 64 is provided between the external surface of the fuel conduit 52 and the walls of the bore 50. The insulating gap 64 provides thermal protection for the fuel in the fuel conduits 52, 54, and 56. The housing stem 42 has a thickness sufficient to support nozzle 40 in the combustor when the injector is mounted to the engine, and is formed of material appropriate for the particular application.

The lower end of the housing stem 42 includes an annular outer shroud 70 circumscribing a longitudinal axis A of the nozzle 40. The outer shroud 70 is connected at its downstream end to an annular outer air swirler 72, such as by welding or brazing at 74. The outer air swirler 72 includes an annular wall 76 forming a continuation of the shroud 70 and from which swirler vanes 78 may project radially outwardly to an annular shroud 80. The interior of the shroud 80 is tapered inwardly at its downstream end 82 to direct air in a swirling manner toward the central axis A at a discharge end 84 of the nozzle 40.

The outer shroud 70 and outer air swirler 72 surround a fuel swirler 90 tapered inwardly at its downstream end and an inner annular heat shield 92 that is disposed radially inwardly of the fuel swirler 90. The inner annular heat shield 92 has a radially inner surface 94 bounding an air passage (duct) 96 in which an air swirler 98 with radially-extending swirler blades 100 may be provided. The air swirler 98 directs air in a swirling manner along the central axis A of the nozzle 40 to the discharge end 84 of the nozzle 40. The inner heat shield 92 extends centrally within the nozzle. The inner heat shield 92 and fuel swirler 90 respectively form external and internal walls of the nozzle 40 that have an insulating gap 102 therebetween that functions to protect the fuel from the elevated temperatures. The insulating gap 102 may be connected by a suitable passage in the nozzle 40 to the insulating gap 64 of the housing stem 42 for venting, if desired.

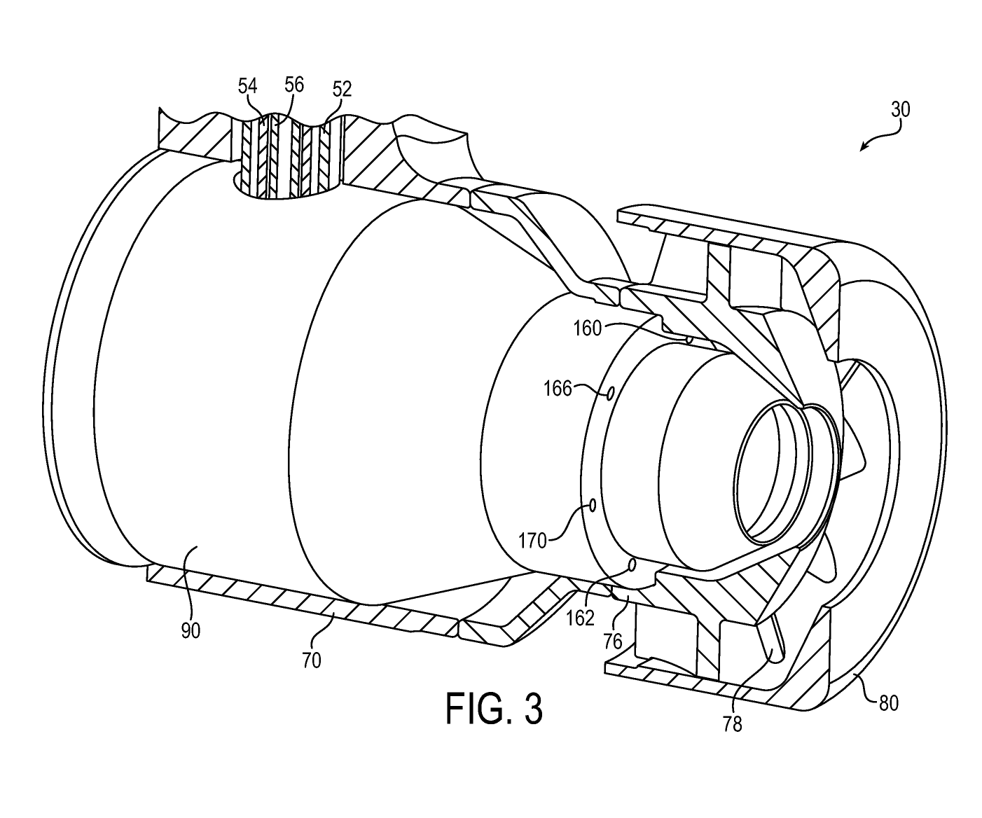

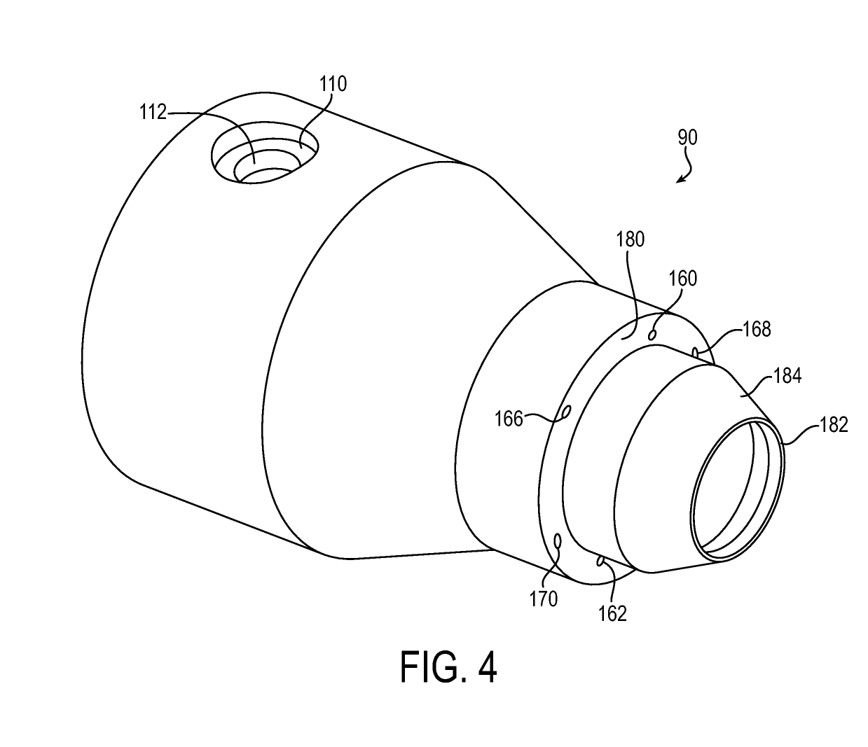

Turning now to FIGS. 3-5 in addition to FIG. 2, the fuel swirler 90 will be discussed in detail. The fuel swirler 90 includes a plurality of inlet chambers, illustrated as first, second and third inlet chambers 110, 112, and 114 fluidly connected to respective fuel conduits 52, 54, and 56, a plurality of sets of multiple exit orifices, illustrated as first, second and third sets of orifices 116, 118, and 120, and a plurality of sets of multiple flow passages, illustrated as first, second, and third sets of flow passages 122, 124, and 126 extending through the fuel swirler 90. The inlet chambers, exits orifices, and flow passages may be formed in the fuel swirler 90, for example by additive machining methods such as direct laser deposition, direct metal laser sintering, etc., such that the fuel swirler 90 is of unitary construction.

The inlet chambers 110, 112, and 114 are shown as annular concentric chambers at an upstream end of the fuel swirler 90. The inlet chambers 110, 112, and 114 may be fluidly sealed and coupled to the respective fuel conduits 52, 54 and 56 in any suitable manner, such as welding or brazing, or the fuel conduits 52, 54 and 56 may be allowed to float in the radial direction relative to the inlet chambers 110, 112, and 114. The inlet chambers 110, 112, and 114 are offset from one another radially with respect to the air passage 96 with the inlet chamber 110 extending radially inward from an outer wall of the fuel swirler 90. The inlet chambers 110, 112, and 114 have progressively smaller diameters such that the outermost inlet chamber 110 has the largest diameter and the inner most inlet chamber 114 has the smallest diameter.

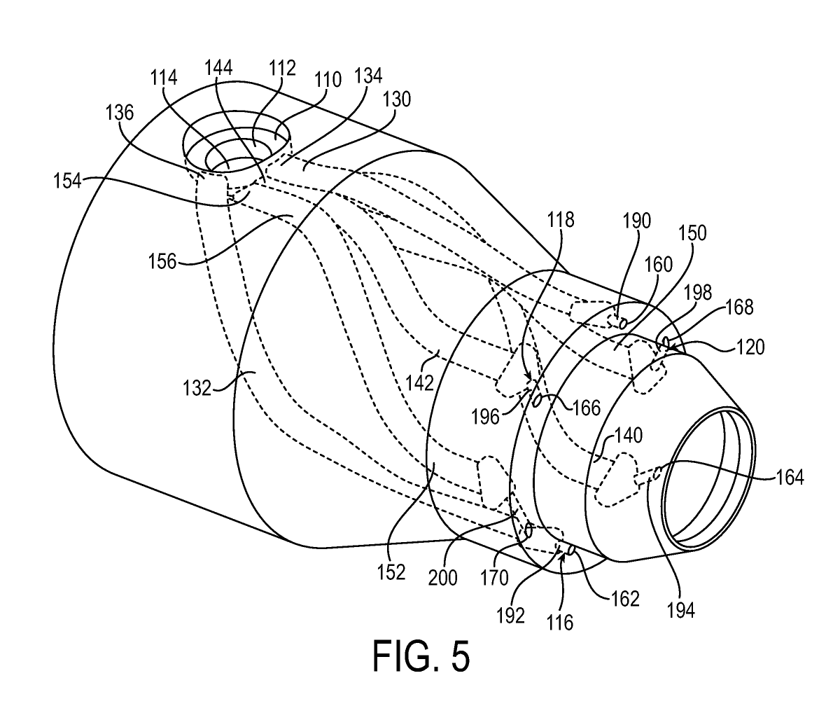

As best shown in FIG. 5, each inlet chamber 110, 112, 114 is fluidly connected to a respective one of the sets of flow passages 122, 124, and 126. The first inlet chamber 110 is connected to the first set of flow passages 122, which is shown having first and second passages 130 and 132, in any suitable manner, such as via openings 134 and 136 in a wall of the inlet chamber 110. The openings 134 and 136, which may be circumferentially and radially spaced from one another, connect the inlet chamber 110 to the first and second passages 130 and 132, respectively. The second inlet chamber 112 is connected to the second set of flow passages 124, which is shown having first and second passages 140 and 142, in any suitable manner, such as via an opening 144 in a wall of the inlet chamber 112. The opening 144 connects the inlet chamber 112 to a common passage 146, which branches off into the first and second passages 140 and 142. The third inlet chamber 114 is connected to the third set of flow passages 126, which is shown having first and second passages 150 and 152, in any suitable manner, such as via an opening 154 in a wall of the inlet chamber 114. The opening 154 connects the inlet chamber 114 to a common passage 156, which branches off into the first and second passages 150 and 152. It will be appreciated that passages 130 and 132 may be connected to the first inlet chamber 110 in a similar manner as the passages 140, 142, 150, and 152 are connected to the respective inlet chambers 112 and 114. Similarly, the passages 140, 142, 150, and 152 may be connected to the respective inlet chambers 112 and 114 in a similar manner as the passages 130 and 132 are connected to the inlet chamber 110.

Each inlet chamber 110, 112, and 114 is fluidly connected with one of the plurality of sets of multiple exit orifices 116, 118, and 120 by a respective set of multiple flow passages 122, 124, and 126. Specifically, the flow passages 130 and 132 fluidly connect the first inlet chamber 110 with respective orifices 160 and 162 of the first set of multiple exit orifices 116, the flow passages 140 and 142 fluidly connect the second inlet chamber 112 with respective orifices 164 and 166 of the second set of multiple exit orifices 118, and the flow passages 150 and 152 fluidly connect the third inlet chamber 114 with respective orifices 168 and 170 of the third set of multiple exit orifices 120.

The orifices 160, 162, 164, 166, 168, and 170 are arranged in an annular array with the orifices of one set alternating with the orifices of the other sets. Alternately, it will be appreciated that the orifices may be arranged in other suitable arrangements. For example, if a set of orifices includes more than two orifices, multiple orifices of the set may be adjacent one another and alternating with multiple orifices of another set. In another embodiment, the orifices may be arranged on one or more sides, for example to direct fuel to an igniter.

The orifices terminate at an end face 180 of the fuel swirler 90 upstream of a common prefilmer orifice 182 to direct fluid towards a prefilmer surface 184 terminating at the prefilmer orifice 182. The orifices 160, 162, 164, 166, 168, and 170 may have varying angles and varying cross-sectional areas to increase/decrease the amount of swirling of the fuel and/or to increase/decrease the velocity of the fuel exiting the orifices for staging the fuel. In this way, multiple flow passages fluidly separated from one another may be provided in the fuel swirler 90 to allow for varying fuel metering and fuel swirl during staging, while sharing the common prefilmer orifice 182, for example for airblast atomizer applications.

To vary the angle of fuel exiting the orifices, each flow passage 130, 132, 140, 142, 150, and 152 has a terminal portion 190, 192, 194, 196, 198, and 200, respectively, angled with respect to the axis A and terminating at the respective orifice. The terminal portions may be formed in the fuel swirler 90 as discussed above or machined into the fuel swirler 90 such that the terminal portions extend from a downstream end of the respective flow passages to the respective exit orifice. The terminal portions 190 and 192 of the first set of multiple flow passages 122 are shown at a first angle, the terminal portions 194 and 196 of the second set of multiple flow passages 124 are shown at a second angle, and the terminal portions 198 and 200 of the third set of multiple flow passages 126 are shown at a third angle, where the first, second, and third angles are different from one another. The first angle of the terminal portions 190 and 192 is shown as a zero angle with respect to the axis A to create a zero swirl flow, the second angle of the terminal portions 194 and 196 is shown as a medium angle, such as approximately forty-five degrees with respect to the axis A to create a medium swirl flow, and the third angle of the terminal portions 198 and 200 is shown as a high angle with respect to the axis A to create a high swirl flow. By providing the terminal portions 190, 192, 194, 196, 198, and 200 at varying angles, various swirl strengths may be achieved that create various fuel spray angles at different operating conditions.

To vary the cross-sectional area of the fuel exiting the orifices, the terminal portions 190 and 192 of the first set of multiple flow passages 122 have a first cross-sectional area, the terminal portions 194 and 196 of the second set of multiple flow passages 124 have a second cross-sectional area, and the terminal portions 198 and 200 of the third set of multiple flow passages 126 have a third cross-sectional area, where the first, second and third cross-sectional areas are different from one another. The first cross-sectional area of the terminal portions 190 and 192 is greater than the second cross-sectional area of the terminal portions 194 and 196, which is greater than the third cross-sectional area of the terminal portions 198 and 200. The fuel flowing through the terminal portions 198 and 200 thereby has the highest velocity, which assists in increasing the swirl angle of the fuel. By providing the terminal portions 190, 192, 194, 196, 198, and 200 with varying cross-sectional areas, varying flow rates may be achieved at desired pressure ranges and operating conditions.

In an embodiment, at low power conditions and during startup, the flow through the nozzle could be staged such that fuel flows through the fuel conduit 56 into the third inlet chamber 114 and through the flow passages 150 and 152, where the fuel exits the orifices 168 and 170 having the highest swirl angle. By widening the spray angle of the nozzle 40, stability, ignition performance, and operability may be increased. After startup, the flow could be staged to the first and/or second sets of multiple flow passages 122 and 124 to narrow the spray angle, thereby reducing NOx emissions by lowering residence times in the combustor 20 and decreasing fuel impinging on the combustor walls, which improves combustor durability by reducing temperatures near the combustor wall. In another embodiment, during staging of the sets of multiple flow passages 122, 124, and 126, the fuel metering for the flow passages 126 could be increased to increase operating pressure at low power conditions and during startup, thereby increasing fluid velocities and improving atomization at low power conditions and during startup up.

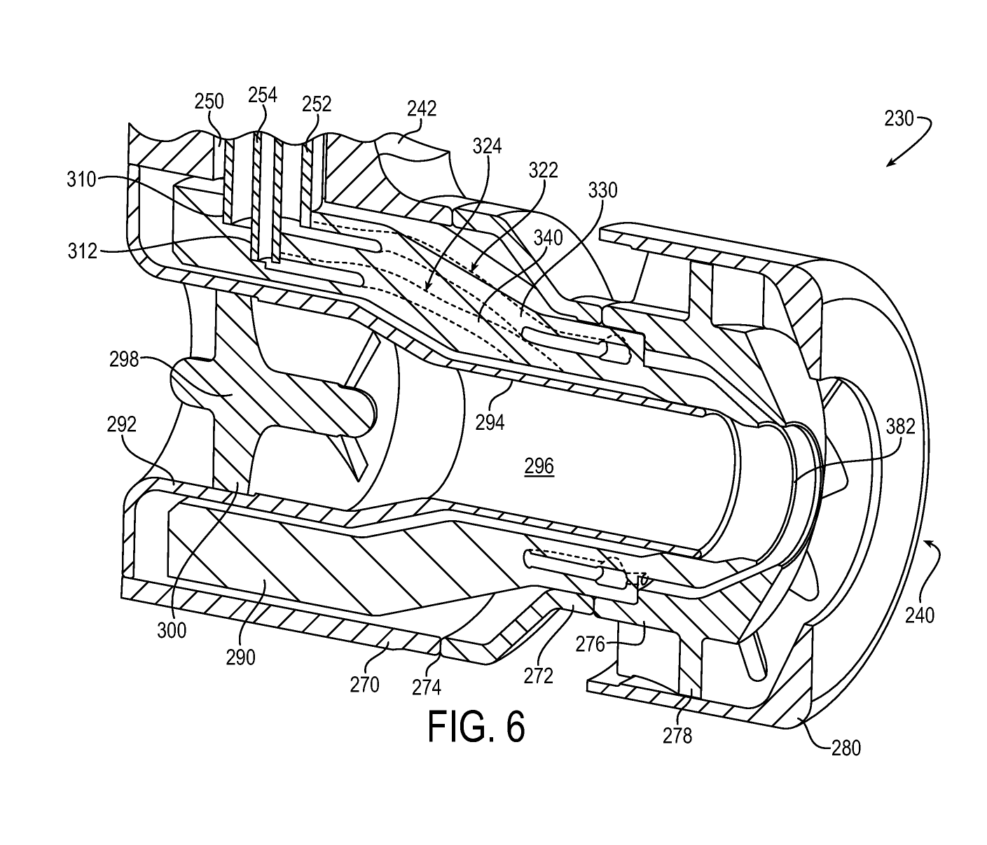

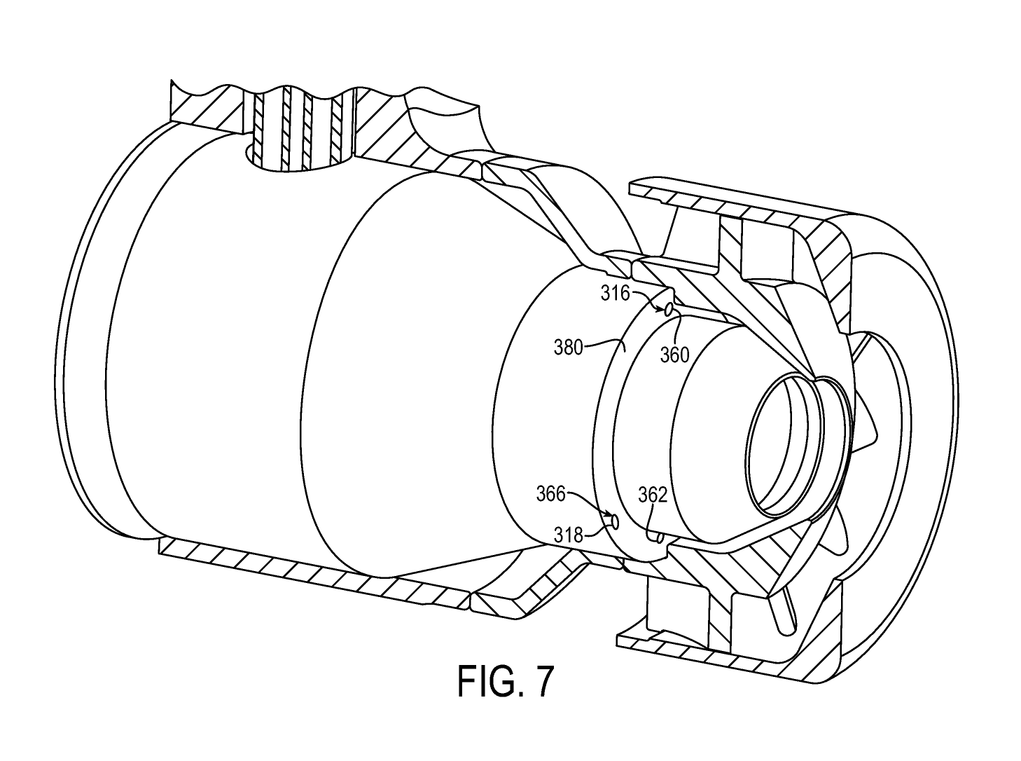

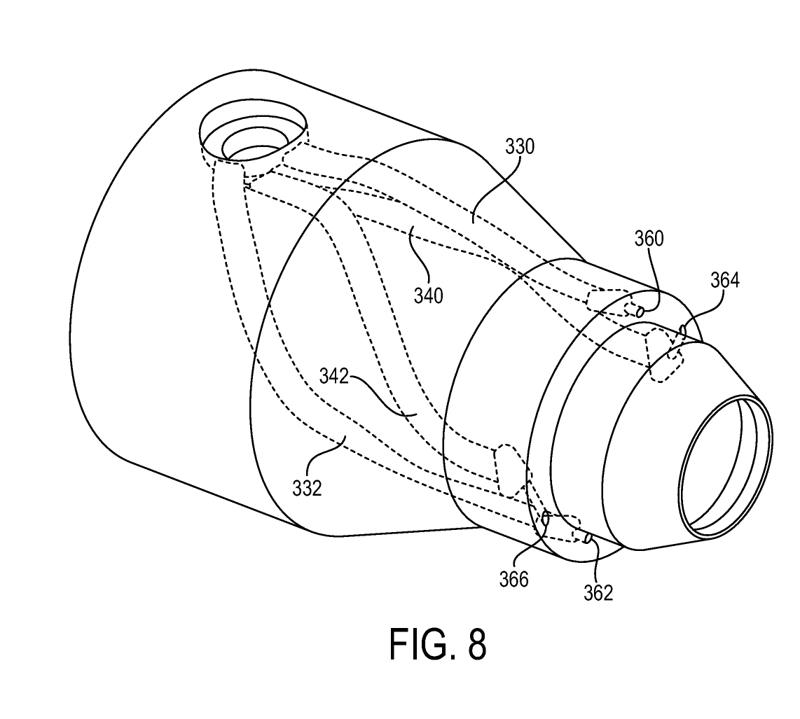

Turning now to FIGS. 6-8, an exemplary embodiment of the fuel injector is shown at 230. The fuel injector 230 is substantially the same as the above-referenced fuel injector 30, and consequently the same reference numerals but indexed by 200 are used to denote structures corresponding to similar structures in the fuel injectors. In addition, the foregoing description of the fuel injector 30 is equally applicable to the fuel injector 230 except as noted below. Moreover, it will be appreciated upon reading and understanding the specification that aspects of the fuel injectors may be substituted for one another or used in conjunction with one another where applicable.

The fuel injector 230 includes a housing stem 242 having a bore 250 through which fuel conduits 252 and 254 extend. The lower end of the housing stem 242 includes an annular outer shroud 270 connected at its downstream end to an annular outer air swirler 272, such as by welding or brazing at 274. The outer air swirler 272 includes an annular wall 276 forming a continuation of the shroud 270 and from which swirler vanes 278 may project radially outwardly to an annular shroud 280. The outer shroud 270 and outer air swirler 272 surround a fuel swirler 290 and an inner annular heat shield 292 that is disposed radially inwardly of the fuel swirler 290. The inner annular heat shield 292 has a radially inner surface 294 bounding an air passage (duct) 296 in which an air swirler 298 with radially-extending swirler blades 300 may be provided.

The fuel swirler 290 includes first and second inlet chambers 310 and 312 fluidly connected to respective fuel conduits 252 and 254, first and second sets of orifices 316 and 318, and first and second sets of flow passages 322 and 324 extending through the fuel swirler 290. The first inlet chamber 310 is connected to the first set of multiple flow passages 322 having first and second passages 330 and 332 and the second inlet chamber 312 is connected to the second set of multiple flow passages 324 having first and second passages 340 and 342. The flow passages 330 and 332 fluidly connect the first inlet chamber 310 with respective orifices 360 and 362 of the first set of multiple exit orifices 316, and the flow passages 340 and 342 fluidly connect the second inlet chamber 312 with respective orifices 364 and 366 of the second set of multiple exit orifices 318.

The orifices 360 and 362 alternate with the orifices 364 and 366 in an annular array, and terminate at an end face 380 of the fuel swirler 290 upstream of a common prefilmer orifice 382. To vary the angle of fuel exiting the orifices, each flow passage 330, 332, 340 and 342 has a respective terminal portion 390, 392, 394 and 396. The terminal portions 390 and 392 are shown at a first angle and the terminal portions 394 and 396 are shown at a second angle different from the first angle. The first angle of the terminal portions 390 and 392 may be a low angle with respect to the axis A to create a low swirl flow, and the second angle of the terminal portions 394 and 396 may be a high angle with respect to the axis A to create a high swirl flow. To vary the cross-sectional area of the fuel exiting the orifices 360, 362, 364, and 366, the terminal portions 390 and 392 have a first cross-sectional area and the terminal portions 394 and 396 have a second cross-sectional area less than the cross-sectional area of the terminal portions 390 and 392.

In an embodiment, at low power conditions and during startup, the flow through the nozzle could be staged such that fuel flows through the high swirl flow passages 340 and 342 to widen the spray angle. By widening the spray angle of the nozzle 240, stability, ignition performance, and operability may be increased. After startup, the flow could be staged to low swirl flow passages 330 and 332 and may continue until the flow through the nozzle is predominately through the flow passages 330 and 332 to narrow the spray angle. By narrowing the spray angle, residence times in the combustor are lowered and fuel impingement on the combustor walls is decreased, thereby reducing NOx emissions. In another embodiment, during staging of the flow passages 330, 332, 340, and 342, the fuel metering for the flow passages 340 and 342 could be increased to increase operating pressure at low power conditions and during startup, thereby increasing fluid velocities and improving atomization at low power conditions and during startup up.

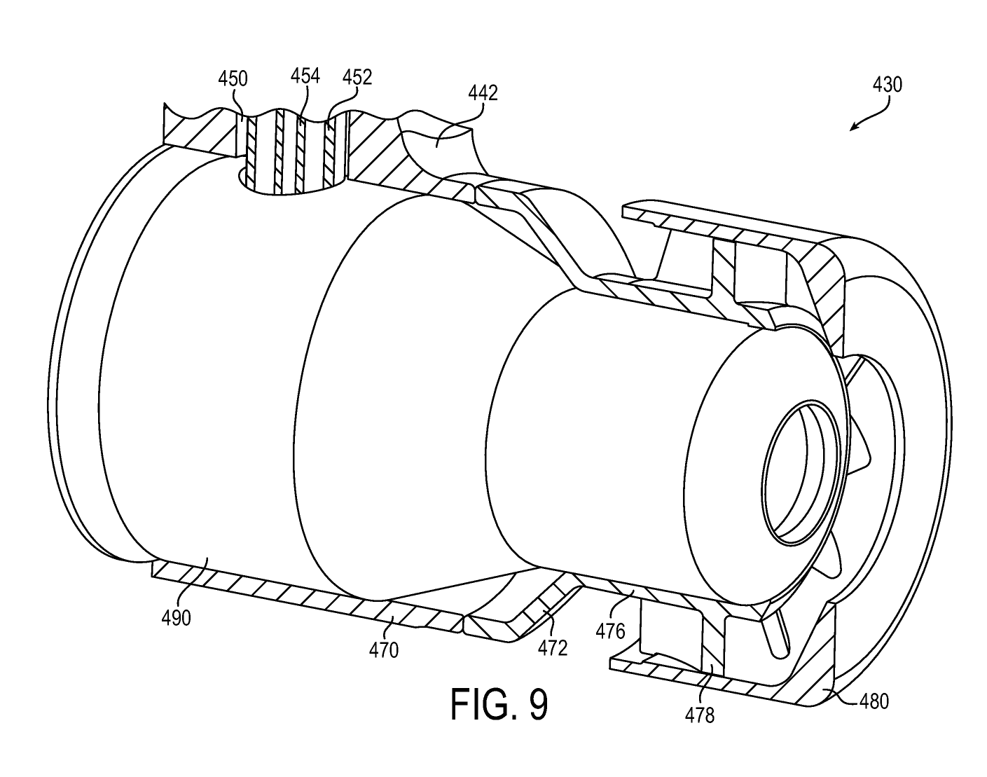

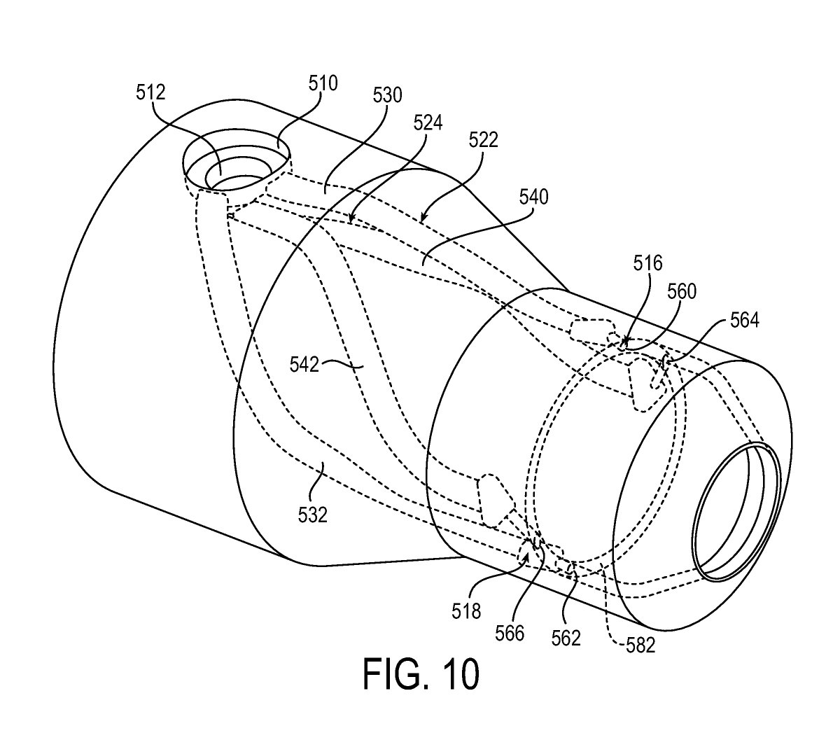

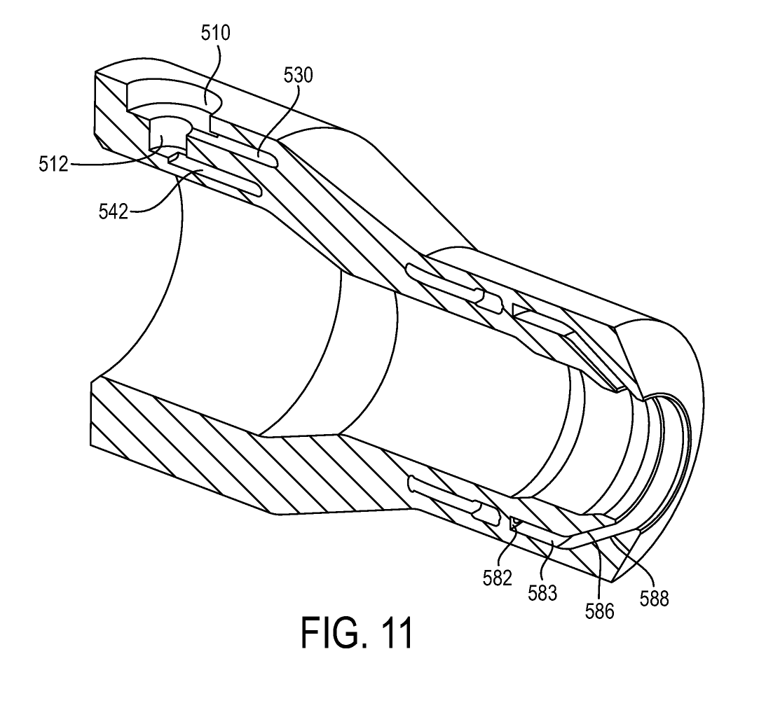

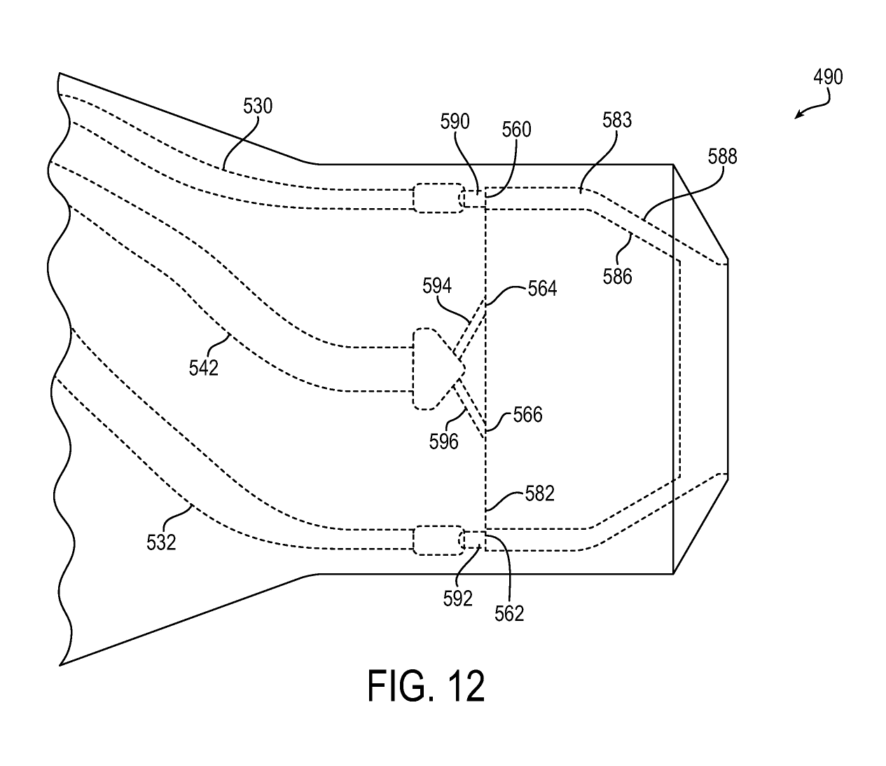

Turning now to FIGS. 9-12, an exemplary embodiment of the fuel injector is shown at 430. The fuel injector 430 is substantially the same as the above-referenced fuel injector 230, and consequently the same reference numerals but indexed by 200 are used to denote structures corresponding to similar structures in the fuel injectors. In addition, the foregoing description of the fuel injector 230 is equally applicable to the fuel injector 430 except as noted below. Moreover, it will be appreciated upon reading and understanding the specification that aspects of the fuel injectors may be substituted for one another or used in conjunction with one another where applicable.

The fuel injector 430 includes a housing stem 442 having a bore 450 through which fuel conduits 452 and 454 extend. The lower end of the housing stem 442 includes an annular outer shroud 470 connected at its downstream end to an annular outer air swirler 472, such as by welding or brazing at 474. The outer air swirler 472 includes an annular wall 476 forming a continuation of the shroud 470 and from which swirler vanes 478 may project radially outwardly to an annular shroud 480. The outer shroud 470 and outer air swirler 472 surround a fuel swirler 490 and an inner annular heat shield (not shown) that is disposed radially inwardly of the fuel swirler 490.

The fuel swirler 490 includes first and second inlet chambers 510 and 512 fluidly connected to respective fuel conduits 452 and 454, first and second sets of orifices 516 and 518, and first and second sets of flow passages 522 and 524 extending through the fuel swirler 490. The first inlet chamber 510 is connected to the first set of multiple flow passages 522 having first and second passages 530 and 532 and the second inlet chamber 512 is connected to the second set of multiple flow passages 524 having first and second passages 540 and 542. The flow passages 530 and 532 fluidly connect the first inlet chamber 510 with respective orifices 560 and 562 of the first set of multiple exit orifices 516, and the flow passages 540 and 542 fluidly connect the second inlet chamber 512 with respective orifices 564 and 566 of the second set of multiple exit orifices 518.

The orifices 560 and 562 alternate with the orifices 564 and 566 in an annular array, and terminate at an internal end face 580 of the fuel swirler 290. Fuel exits the orifices 560-566 at the end face 580 and is directed into a passage 583 formed between an inner wall portion 586 of the fuel swirler 290 and an outer wall portion 588 of the fuel swirler surrounding the inner wall portion 586 downstream of the internal end face 580.

While several embodiments of a nozzle have been described above, it should be apparent to those skilled in the art that other nozzle (and stem) designs can be configured in accordance with the present invention. The invention is not limited to any particular nozzle design, but rather is appropriate for a wide variety of commercially-available nozzles, including nozzles for other applications where the nozzle is subjected to ambient high temperature conditions.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application

What is claimed is:

1. A nozzle for an injector including:
an air swirler; and
a nozzle body disposed interiorly of the air swirler, the nozzle body including a plurality of inlet chambers configured to be fluidly connected to respective fuel circuits, a plurality of sets of multiple exit orifices arranged in an annular array with the orifices of one set alternating with the orifices of another set, and a plurality of sets of multiple flow passages extending through the nozzle body,
wherein each of the multiple flow passages is fluidly connected to one of the exit orifices, and
wherein each set of multiple flow passages fluidly connects one of the plurality of inlet chambers with one of the plurality of sets of multiple exit orifices.

2. The nozzle according to claim 1, wherein the plurality of exit orifices terminate at an end face of the nozzle body upstream of a common prefilmer orifice of the air swirler and are configured to direct fluid towards a prefilmer surface terminating at the prefilmer orifice.

3. The nozzle according to claim 1, further including an inner annular wall disposed interiorly of the fuel swirler and defining an air passage through which air flows.

4. The nozzle according to claim 3, wherein the plurality of inlet chambers are offset from one another radially with respect to the air passage.

5. The nozzle according to claim 1, wherein the plurality of inlet chambers are concentric.

6. The nozzle according to claim 1, wherein a terminal portion of each flow passage of one of the sets of multiple flow passages has a cross-sectional area less than a cross-sectional area of a terminal portion of each flow passage of another set of multiple flow passages.

7. The nozzle according to claim 6, wherein each terminal portion of each flow passage in each set of multiple flow passages has the same cross-sectional area as the other terminal portions in the same set of multiple flow passages.

8. The nozzle according to claim 1, wherein each flow passage includes a terminal portion angled with respect to a central axis circumscribed by the nozzle body for directing fuel to the respective exit orifice, wherein the terminal portions of one of the sets of multiple flow passages are angled at a different angle than the terminal portions of another of the sets of multiple flow passages such that the fluid exiting each set of multiple exit orifices has a different spray angle than the other sets of orifices.

9. The nozzle according to claim 8, wherein each terminal portion of each flow passage in each set of multiple flow passages is angled with respect to the central axis at the same angle as the other terminal portions in the same set of multiple flow passages.

10. The nozzle according to claim 8, wherein each terminal portion is formed by a passage extending between a downstream end of the respective flow passage and the respective exit orifice.

11. The nozzle according to claim 1, wherein each set of multiple exit orifices has a spray angle that is angled with respect to a central axis circumscribed by the nozzle body such that the fluid exiting each set of multiple exit orifices has a different spray angle than the fluid exiting the other sets of multiple exit orifices.

12. The nozzle according to claim 1, wherein the nozzle body has a unitary construction.

13. A nozzle including:
an air swirler; and
a nozzle body disposed interiorly of the air swirler, the nozzle body including a plurality of inlet chambers configured to be fluidly connected to respective fuel circuits, a plurality of sets of multiple passages respectively fluidly connected to one of the inlet chambers, and a plurality of exit orifices respectively fluidly connected to one of the flow passages,
wherein the plurality of exit orifices terminate at an end face of the nozzle body upstream of a common prefilmer orifice and direct fluid towards a prefilmer surface terminating at the prefilmer orifice.

14. The nozzle according to claim 13, wherein the exit orifices direct the fluid towards the prefilmer orifice between a tip of the nozzle body and the air swirler.

15. The nozzle according to claim 13, wherein a terminal portion of each flow passage of one of the sets of multiple flow passages has a cross-sectional area less than a cross-sectional area of a terminal portion of each flow passage of another set of multiple flow passages.

16. The nozzle according to claim 13, wherein each flow passage includes a terminal portion angled with respect to a central axis circumscribed by the nozzle body for directing fuel to the respective exit orifice, wherein the terminal portions of one of the sets of multiple flow passages are angled at a different angle than the terminal portions of another of the sets of multiple flow passages such that the fluid exiting each set of multiple exit orifices has a different spray angle than the other sets of orifices.

17. The nozzle according to claim 13, wherein each set of multiple exit orifices has a spray angle that is angled with respect to a central axis circumscribed by the nozzle body such that the fluid exiting each set of multiple exit orifices has a different spray angle than the fluid exiting the other sets of multiple exit orifices.

18. A fuel injector including:
a housing stem having a bore extending therethrough;
first and second fuel conduits extending through the bore; and
a nozzle supported by the stem, the nozzle including:
an air swirler coupled to a downstream end of the housing stem;
a nozzle body disposed interiorly of the housing stem and air swirler; and
an inner annular wall disposed interiorly of the nozzle body and defining an air passage through which air flows,
wherein the nozzle body includes a plurality of inlet chambers offset from one another radially with respect to the air passage, a plurality of flow passages fluidly connected to each inlet chamber, and a plurality of exit orifices each fluidly coupled to one of the plurality of flow passages.

19. The fuel injector according to claim 18, wherein the inlet chambers have progressively smaller diameters.

20. The fuel injector according to claim 18, further including an annular shroud surrounding a downstream end of the air swirler for directing air flowing through swirler vanes of the air swirler radially inwardly.
